(19) United States
(12) Patent Application Publication
(10) Pub. No.: US 2026/0188703 A1
(43) Pub. Date: Jul. 2, 2026

(54) CYLINDRICAL ELECTROCHEMICAL CELLS AND METHODS OF FORMING THE SAME

(71) Applicant: Medtronic, Inc., Minneapolis, MN (US)

(72) Inventor: Joseph J. Viavattine, Vadnais Heights, MN (US)

(21) Appl. No.: 19/116,498

(22) PCT Filed: Sep. 8, 2023
(86) PCT No.: PCT/IB2023/058929

§ 371 Date: Mar. 28, 2025

Related U.S. Application Data
(60) Provisional application No. 63/412,319, filed on Sep. 30, 2022.

(51) Int. Cl. H01M 4/80; H01M 4/02; H01M 4/04; H01M 4/66; H01M 10/04

(52) U.S. Cl. CPC H01M 4/80; H01M 4/0404; H01M 4/043; H01M 4/661; H01M 4/668; H01M 10/0422; H01M 10/0431; H01M 2004/021; H01M 2004/028

(57) ABSTRACT

An electrochemical cells and methods of making the same are disclosed. An electrochemical cell may include a cell housing and a cell core disposed in the cell housing. The cell body may extend along a longitudinal axis from a distal end to a proximal end. The cell core may include a cathode electrode, an anode electrode, and a separator disposed between the cathode electrode and the anode electrode. The cathode electrode may define a plurality of cathode windings around the longitudinal axis. Each cathode winding may include a porous conductive strip and a cathode active material disposed on the porous conductive strip. The anode electrode may be disposed around the cathode electrode.

This application claims the benefit of U.S. Provisional Patent Application Ser. No. 63/412,319, filed 30 Sep. 2022, the entire content of which is incorporated herein by reference.

### FIELD

The present disclosure relates to, among other things, cylindrical cell batteries or electrochemical cells.

### TECHNICAL BACKGROUND

Cylindrical cell batteries or electrochemical cells are generally easy to manufacture and provide robust mechanical stability. Such cylindrical cell batteries or electrochemical cells may include an anode, cathode, and a separator in the form of strips wound in a spiral or coil. In general, batteries or cells may be designed to have a higher energy density with a lower power output or to have a higher power output with a lower energy density. To provide cells with a higher power output, thin electrodes with relatively large surface areas may be used. In contrast, to provide cells with a higher energy density, designs may seek to maximize cathode volume and minimize other inactive volumes. However, thicker cathodes may result in larger distances between the cathode current collector and the surface of the cathode that opposes the anode. Such larger distances may result in increased internal cell resistance. While the resistivity of the cathode active material plays into the overall resistance, the geometry of the cathode may contribute substantially to the overall internal resistance especially as battery and cell designs or components become smaller.

### BRIEF SUMMARY

As described herein, cylindrical batteries and electrochemical cells with a relatively high energy density and decreased internal resistance can be achieved using a cathode electrode wound about itself. Windings of the cathode electrode may include a cathode active material disposed on a porous conductive strip. Such wound cathode electrodes may allow the use of large cathode volumes relative to other inactive volumes while keeping internal resistances low. Additionally, the porous conductive strip may provide a support substrate for the cathode active material.

Described herein, among other things, is an electrochemical cell comprising a cell housing and a cell core disposed in the cell housing. The cell body may extend along a longitudinal axis from a distal end to a proximal end. The cell core may comprise a cathode electrode, an anode electrode, and a separator disposed between the cathode electrode and the anode electrode. The cathode electrode may define a plurality of cathode windings around the longitudinal axis. Each cathode winding may comprise a porous conductive strip and a cathode active material disposed on the porous conductive strip. The anode electrode may be disposed around the cathode electrode.

In general, in one aspect, the present disclosure describes a method for forming an electrochemical cell. The method may comprise providing a porous conductive strip and disposing a cathode active material on the porous conductive strip to form a cathode electrode. The method may further comprise winding the cathode electrode about a longitudinal axis to form a plurality of cathode windings, disposing a separator around the cathode electrode, disposing an anode electrode around the separator to form a cell core, and disposing the cell core into a cell housing.

Advantages and additional features of the subject matter of the present disclosure will be set forth in the detailed description which follows, and in part will be readily apparent to those skilled in the art from that description or recognized by practicing the subject matter of the present disclosure as described herein, including the detailed description which follows, the claims, as well as the appended drawings.

It is to be understood that both the foregoing general description and the following detailed description present embodiments of the subject matter of the present disclosure, and are intended to provide an overview or framework for understanding the nature and character of the subject matter of the present disclosure as it is claimed. The accompanying drawings are included to provide a further understanding of the subject matter of the present disclosure and are incorporated into and constitute a part of this specification. The drawings illustrate various embodiments of the subject matter of the present disclosure and together with the description serve to explain the principles and operations of the subject matter of the present disclosure. Additionally, the drawings and descriptions are meant to be merely illustrative and are not intended to limit the scope of the claims in any manner.

### BRIEF DESCRIPTION OF THE DRAWINGS

The following detailed description of specific embodiments of the present disclosure can be best understood when read in conjunction with the following drawings, in which:

FIG. 1 is an isometric view of an embodiment of an electrochemical cell;

FIG. 2 is a cross-sectional view of the electrochemical cell of FIG. 1;

FIG. 3A is a cross-sectional view of a cell core of the electrochemical cell of FIGS. 1 and 2;

FIG. 3B is a cross-sectional view of a cathode electrode of the electrochemical cell of FIGS. 1 and 2;

FIG. 4A is a top-down view of a cathode electrode of the electrochemical cell of FIGS. 1 and 2 in an unwound state.

FIG. 4B is a top-down view of a porous conductive strip of the electrochemical cell of FIGS. 1 and 2 in an unwound state.

FIG. 5 is a cross-sectional view of another embodiment of an electrochemical cell;

FIG. 6 is flow diagram of an embodiment of a method or process for forming an electrochemical cell.

The schematic drawing is not necessarily to scale.

### DETAILED DESCRIPTION

Reference will now be made in greater detail to various embodiments of the subject matter of the present disclosure, one or more embodiments of which are illustrated in the accompanying drawings. Like numbers used in the figures refer to like components and steps. However, it will be understood that the use of a number to refer to a component in a given figure is not intended to limit the component in another figure labeled with the same number. In addition, the use of different numbers to refer to components in different figures is not intended to indicate that the different numbered components cannot be the same or similar to other numbered components.

Cylindrical batteries or electrochemical cells may include a cylindrically shaped cathode electrode that surrounds a current collector or core. In such cylindrical battery or cell designs, the resistance of a cathode can be calculated by integrating an annular thickness of the cathode electrode from the core to the outer radius. Such a calculation shows that the resistance of the cathode electrode increases as the inner or starting radius of the cathode decreases. In other words, the resistance of the cathode electrode is greater when the thickness of the cathode active material is greater. Accordingly, small pin diameters as a core may result in a high resistance of the cathode electrode and, by extension, a high internal resistance of the cell. Furthermore, interfacial resistance of the core or cathode current collector may also increase as the diameter of the core decreases further contributing to internal cell resistance.

To reduce an internal cell resistance and maintain a relatively high energy density, cylindrical batteries or electrochemical cells may include a cathode electrode that includes a porous conductive strip and a cathode active material. The cathode active material may be disposed on the porous conductive strip and the cathode active material and the porous conductive strip may be wound around themselves such the cathode electrode defines a plurality of cathode windings. Batteries or electrochemical cells that include such a cathode electrode may allow the cathode electrode to occupy a large portion of the cell volume while reducing the resistance of the cathode relative to cathodes or cathode electrodes that do not include a porous conductive strip.

Use of the porous conductive strip allows for a smaller distance between an outer surface of cathode active material and components with high electrical conductivity such the porous conductive strip and the cathode current collector or core. By electrically coupling the porous conductive strip to the cathode current collector, the porous conductive strip can act as an extension of the core or current collector. Accordingly, the resistance of a cathode electrode that includes a porous conductive strip as described herein is significantly reduced compared to cathode or cathode electrode having the same inner and outer diameters without a porous conductive strip.

The porous conductive strip may allow ion transfer within inner layers or windings of the cathode electrode. The porous conductive strip may be perforated or include holes to electrolyte to penetrate to inner layers or windings of the cathode electrode. Accordingly, the porous conductive strip may facilitate ion transfer within inner layers or windings of the cathode electrode because the electrolyte provides a medium for ion transfer between anodes and electrodes with batteries or electrochemical cells. In contrast, solid or nonporous strips may restrict or prevent electrolyte of the battery or electrochemical cell from reaching inner layers of the cathode electrode. Thus, ion transfer in a cathode electrode that include solid or nonporous strips may be reduced or restricted relative to cathode electrodes that include porous conductive strips.

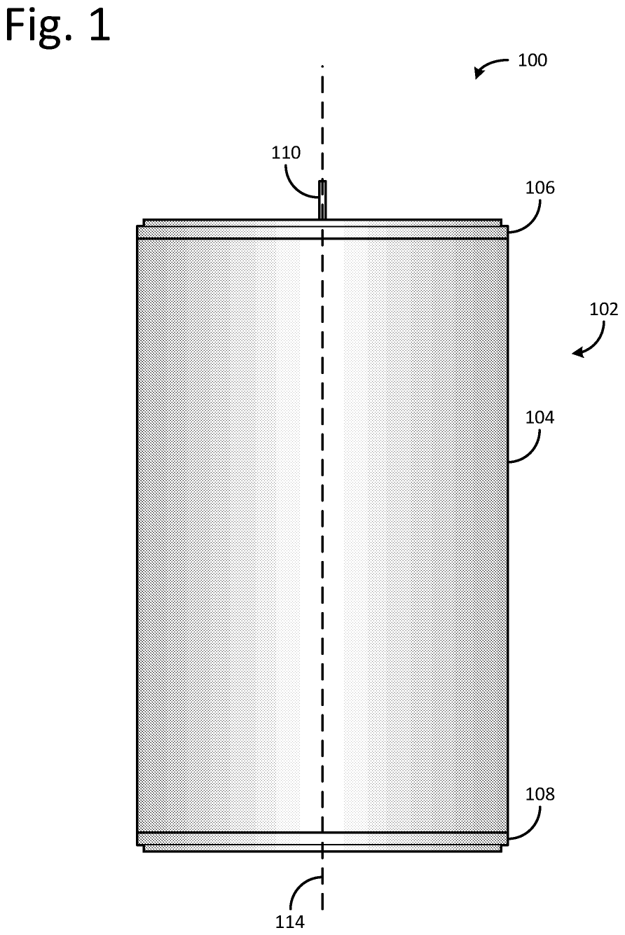

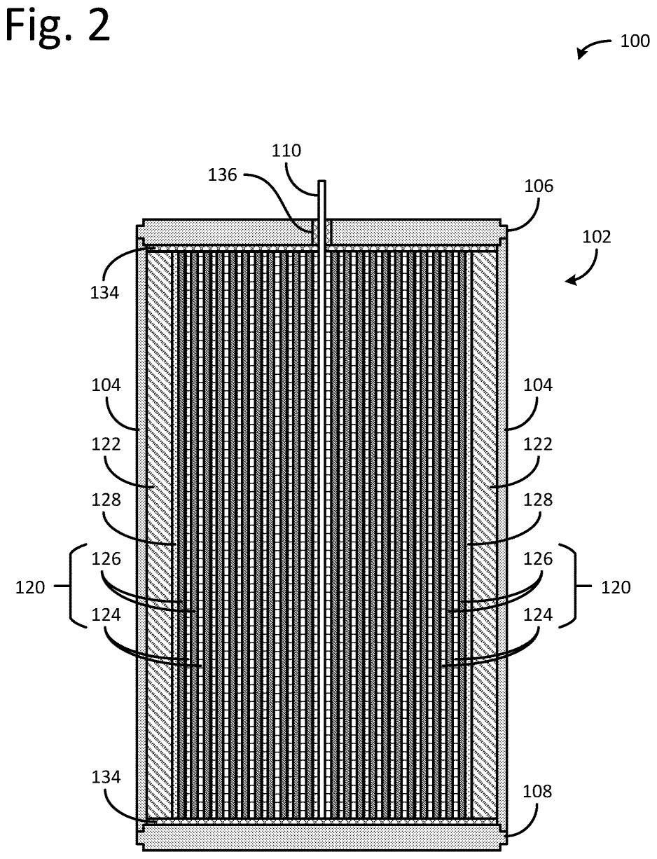

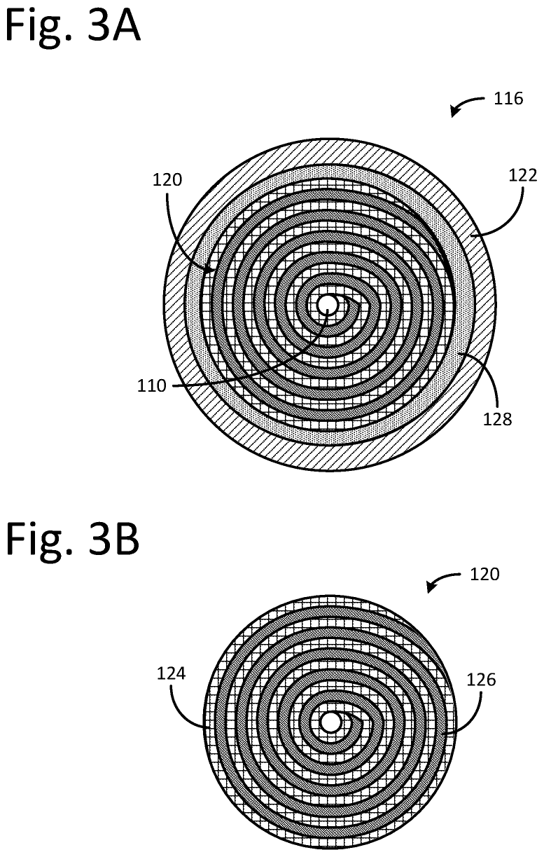

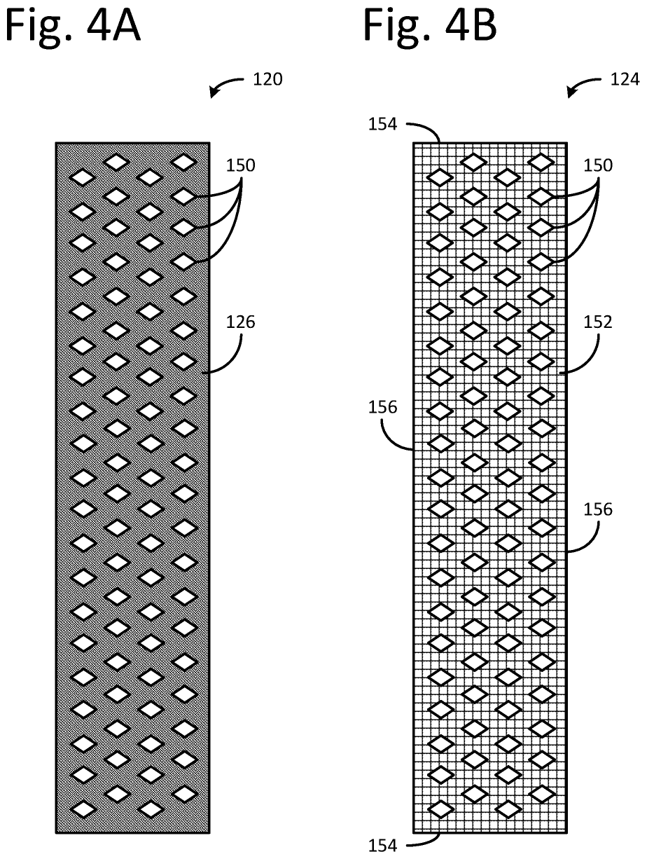

An electrochemical cell 100 that includes a cathode electrode with a porous conductive strip as described herein, is depicted in FIGS. 1 and 2. FIG. 1 shows a side view of an electrochemical cell 100. FIG. 2 shows a side cross-sectional view of the electrochemical cell 100. Additionally, an overhead cross-sectional view of a cell core 116 of the electrochemical cell 100 of FIGS. 1 and 2 is shown in FIG. 3A. Furthermore, a cathode electrode 120 of the electrochemical cell 100 of FIGS. 1 and 2 is shown wound about a longitudinal axis in FIG. 3B and unwound in FIG. 4A. Still further, an unwound porous conductive strip 124 of the cathode electrode 120 is shown in FIG. 4B. The electrochemical cell 100 may be any suitable electrochemical cell type such as, for example, lithium metal, lithium ferrophosphate, or lithium iron phosphate (LFP), lithium nickel manganese cobalt oxide (NMC), lithium nickel cobalt aluminum oxide (NCA), lithium titanate, etc.

The electrochemical cell 100 includes a cell housing 102 and a cell core 116. The cell housing 102 may include a cell body 104 extending along a longitudinal axis 114 from a distal end to a proximal end. As shown, the cell body 104 is a hollow cylinder. However, the cell body 104 may have any suitable outer shape when viewed from above along the longitudinal axis 114. For example, the outer shape of the cell body 104 may be polygonal, elliptical, or a combination of straight and curved edges. The cell body 104 may include one or more materials such as, for example, aluminum, titanium, stainless steel, nickel, nickel coated ferrous steels, or other suitable materials. In one or more embodiments, the cell body 104 may include a polymeric material.

The cell body 104 may also include a distal header 106 coupled to the distal end of the cell body 104 and a proximal header 108 coupled to the proximal end of the cell body 104. The distal header 106 and the proximal header 108 may be coupled to the cell body 104, for example, by an adhesive, a weld process, crimp closure, etc. The distal header 106 and the proximal header 108 may include one or more materials such as, for example, aluminum, stainless steel, nickel, nickel coated ferrous steels, or other suitable materials. In one or more embodiments, distal header 106 and the proximal header 108 may include a polymeric material.

The electrochemical cell may further include a cathode current collector 110. The cathode current collector 110 may include one or more electrically conductive materials such as, for example, titanium, aluminum, copper, etc. The cathode current collector 110 may be electrically coupled to a cathode electrode 120 of the electrochemical cell 100. The cathode current collector 110 may extend through the distal header 106. The cathode current collector 110 may be electrically insulated from the distal header 106 and, by extension, the rest of the cell housing 102 including the cell body 104 and the proximal header 108.

The cell core 116 may be disposed in the cell housing 102. The cell core 116 may include a cathode electrode 120 defining a plurality of cathode windings around the longitudinal axis 114 and an anode electrode 122 disposed around the cathode electrode 120. Additionally, the cell core 116 may include a separator 128 disposed between the cathode electrode 120 and the anode electrode 122. The cell core 116 may further include a winding core extending along the longitudinal axis 114. In one or more embodiments, the winding core may be the cathode current collector 110. In one or more embodiments, the winding core may be an additional component. When the winding core is a separate component from the current collector, the winding core may be electrically coupled to the cathode electrode 120 and the cathode current collector 110. The winding core may be electrically coupled to the cathode electrode 120 and the cathode current collector 110, by, for example, a weld line, a conductive adhesive, solder, etc.

The cathode electrode 120 may include a porous conductive strip 124 and a cathode active material 126. The porous conductive strip 124 may include any suitable conductive material or materials. For example, the porous conductive strip 124 may include one or more of aluminum, copper, silver, gold, conductive polymers, titanium, or other conductive materials. In one or more embodiments, the porous conductive strip 124 is a strip of metal foil. In one or more embodiments, the porous conductive strip 124 is a strip of conductive polymer. The porous conductive strip 124 may include two sides 152, two longitudinal edges 154, and two horizontal edges 156. Additionally, the porous conductive strip 124 may include a plurality of holes or pores 150. The plurality of holes 150 may fluids, molecules, and other particles to pass through the porous conductive strip 124. The plurality of holes 150 may allow electrolyte to pass through the porous conductive strip 124 and facilitate ion transfer between the cathode electrode 120 and the anode electrode 122 within the electrochemical cell 100.

The cathode active material 126 may include any one or more materials such as, for example, lithium-metal oxides (e.g., LiCoO2, LiMn2O4, Li(NixMnyCoz)O2, etc.), vanadium oxides, olivines (e.g., LiFePO4), rechargeable lithium oxides, silver vanadium oxide, carbon monofluoride, manganese dioxide, etc. The cathode active material 126 may be disposed on the porous conductive strip 124. The cathode active material 126 may be disposed on one or both sides 152 of the porous conductive strip 124 or may coat the porous conductive strip 124. In one or more embodiments, the cathode active material 126 may be pressed to one or both sides 152 of the porous conductive strip 124. In one or more embodiments, the porous conductive strip 124 may be coated by the cathode active material 126. In other words, the cathode active material 126 may form a layer of active material on surfaces of the porous conductive strip 124. Such layer of active material may cover almost all surfaces of the porous conductive strip 124 except for a portion large enough to allow the porous conductive strip 124 to be electrically and mechanically coupled to a winding core, the cathode current collector 110, or other conductor.

The porous conductive strip 124 and the cathode active material 126 may be wound about the longitudinal axis 114. In one or more embodiments, the porous conductive strip 124 and the cathode active material 126 may be wound about a winding core that is coextensive with the longitudinal axis 114. Accordingly, each of the windings defined by the cathode electrode 120 may include the porous conductive strip 124 and the cathode active material 126.

The cathode electrode 120 may be electrically coupled to the cathode current collector 110. The cathode electrode 120 may be directly coupled to the cathode current collector 110 or may be electrically coupled to the cathode current collector via one or more conductive elements (not shown) interposed between them. For example, a winding core may be electrically and mechanically coupled to both the cathode electrode 120 and the cathode current collector 110. In one or more embodiments, the current collector 110 may be a winding core. In other words, the cathode current collector 110 may be used to wind the cathode electrode 120 around itself in a method or process for forming the electrochemical cell 100. The cathode electrode 120 may be electrically and mechanically coupled to the cathode current collector 110 or any conductive element therebetween by, for example, a weld line, a conductive adhesive, solder, etc.

The cell core 116 may further include an anode electrode 122 disposed around the cathode electrode 120. The anode electrode 122 may include any one or more materials such as, for example, lithium, graphite, lithium-alloying materials, intermetallic materials (e.g., alloys), silicon, copper, etc. In one or more embodiments, the anode electrode 122 may include a copper foil. The copper foil may include a layer of metallic lithium. The anode electrode 122 may define a hollow cylinder surrounding the cathode electrode 120.

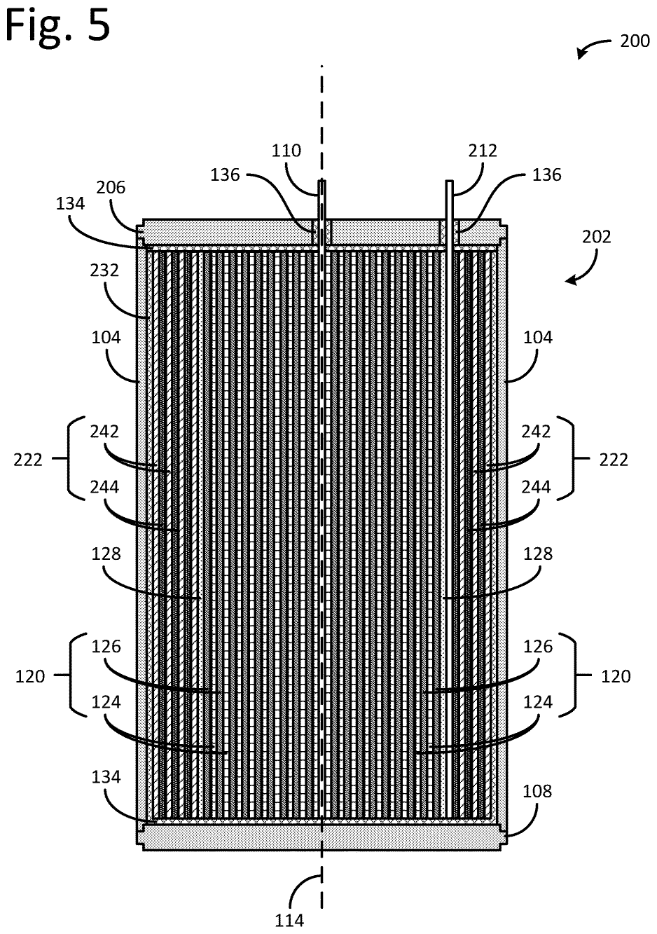

The anode electrode 122 may be electrically coupled to the cell housing 102. In other words, the cell housing 102 may act as an anode current collector and the electrochemical cell may have a “case negative” design. The anode electrode 122 may be electrically coupled to the cell housing 102 by, for example, a weld line, a conductive adhesive, solder, a coupling element, etc. In one or more embodiments, the anode electrode 122 may be electrically isolated from the cell housing 102. When the anode electrode 122 is electrically isolated from the cell housing 102, the anode electrode 122 may be electrically coupled to a separate current collector (e.g., an anode current collector 212 of FIG. 5).

The cell core 116 may further include a separator 128 arranged between the cathode electrode 120 and the anode electrode 122. The separator 128 may define a hollow cylinder or tube that surrounds or “wraps” around the outer diameter of the cathode electrode 120. The separator 128 may be formed of or include electrically insulative material or materials. The separator 128 may include one or more materials such as, for example, Polytetrafluoroethylene (PTFE), cellophane, nylon, polyolefin, etc. Additionally, the separator may be porous to allow ion transfer between the cathode electrode 120 and the anode electrode 122 via an electrolyte.

The electrochemical cell 100 may further include an electrolyte disposed in the cell housing 102. Although not explicitly labeled in the figures, the electrolyte may generally fill at least a portion of any spaces inside the cell housing 102 not filled by the other components of the electrochemical cell 100. The electrolyte may facilitate ion transfer between the cathode electrode 120 and the anode electrode 122. The electrolyte may have an electrical potential. When the cathode electrode 120 and the anode electrode 122 are electrically isolated from the cell housing 102, the cell housing 102 may float at the electrical potential of the electrolyte. The electrolyte may be one or more of, for example, a liquid, a gel, a paste, etc. The material composition of the electrolyte may depend on a cell type of the electrochemical cell 100. The electrolyte may include, for example, lithium salt, sulfuric acid, fluorinated sulfone, or other suitable electrolyte.

The electrochemical cell 100 may also include various insulators to insulate the conductive components (e.g., the cell housing 102; the cathode current collector 110; the cathode electrode 120, the anode electrode 122, etc.) from one another. The electrochemical cell 100 may include coaxial insulators 134. The coaxial insulators 134 may provide an insulative barrier between the edges of the plurality of windings of the cathode electrode 120 and conductive components such as one of the headers 106, 108 or any conductive interconnects. The coaxial insulators 134 may include, for example, Polytetrafluoroethylene (PTFE), Polysulfone, etc.

The electrochemical cell 100 may also include a feedthrough insulator 136. The feedthrough insulator 136 may be disposed in one of the headers 106, 108 to electrically insulate the headers 106, 108 from electrical interconnects such as the cathode current collector 110. The feedthrough insulator 136 may include, for example, glass, ceramic materials (e.g., alumina), or other suitable insulative materials.

Another embodiment of an electrochemical cell 200 is depicted in FIG. 5. The electrochemical cell 200 may include the components and features of the electrochemical cell 100 of FIGS. 1 and 2 with some differences and variations as described below. For example, the anode electrode 222 of the electrochemical cell 200 includes a plurality of windings and the electrochemical cell 200 includes an anode current collector 212 that is separate from the cell housing 202.

Rather than defining a hollow cylinder surrounding the cathode electrode 120, the anode electrode 222 includes a plurality of anode windings around the longitudinal axis 114. The anode electrode may include an anode active material 242 and a porous conductive strip 244. The anode active material 242 may include any one or more materials such as, for example, lithium, graphite, lithium-alloying materials, intermetallic materials (e.g., alloys), silicon, copper, etc. The anode active material may be disposed on the porous conductive strip 244 using any method or process described herein with regard to disposing the cathode active material 126 on the porous conductive strip 124. Similarly, the porous conductive strip 244 may be substantially similar to, and include the features of, the porous conductive strip 124.

Another difference between the electrochemical cell 200 and the electrochemical cell 100 is that the electrochemical cell 200 has a “case neutral” design. In other words, the cell housing 202 may float at the electrolyte potential of the electrochemical cell 200. To achieve a case neutral design, the electrochemical cell may include an anode current collector 212 that extends through the cell housing 202 while being insulated from the cell housing 202 by a feedthrough insulator 136. Accordingly, the distal header 206 of the cell housing 202 may include a feedthrough insulator 136 for each of the current collectors 110, 212. The anode electrode 222 may be electrically coupled to the anode current collector 212. Additionally, the electrochemical cell 200 may include an insulator cup 132 disposed between the plurality of outer windings and the cell housing 102. In one or more embodiments, the insulator cup 132 may include a heat shrinkable material to conform to the shape of the cell core 116. The insulator cup 132 may include, for example, Polytetrafluoroethylene (PTFE), Polysulfone, etc. The insulator cup 132 may be open at one end.

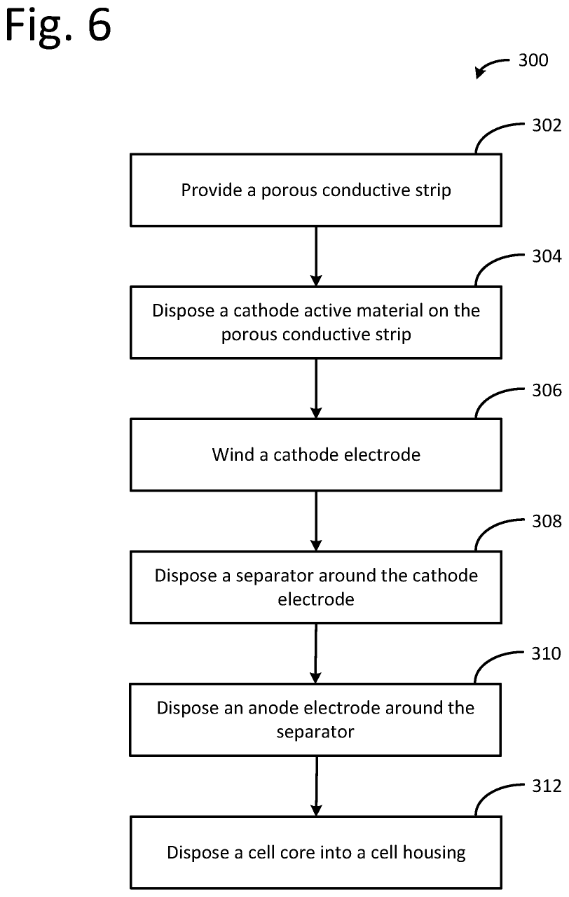

A method or process 300 for forming an electrochemical cell (e.g., electrochemical cell 100 of FIGS. 1 and 2 or electrochemical cell 200 of FIG. 5) is depicted in FIG. 6. The method 300 may include providing a porous conductive strip. The porous conductive strip may include the porous conductive strip 124 of FIGS. 2-4. In one or more embodiments, providing the porous conductive strip may include providing a metal foil and disposing a plurality of holes in the metal foil to form the porous conductive strip. The plurality of holes may be disposed in the metal foil using any suitable technique or techniques such as, for example, mechanical punching, laser cutting, chemical etching, etc. In one or more embodiments, providing the porous conductive strip may include providing a strip of conductive polymer and disposing a plurality of holes in the strip of conductive polymer to form the porous conductive strip. The plurality of holes may be disposed in the strip of conductive polymer using any suitable technique or techniques such as, for example, mechanical punching, laser cutting, etc. In one or more embodiments, the strip of conductive polymer may be formed with holes. In other words, the strip of conductive polymer may be formed using a molding process, deposition process, or other method or process for forming a porous strip of conductive polymer without punching or cutting holes in the conductive polymer.

The method 300 may include disposing a cathode active material on the porous conductive strip to form a cathode electrode 304. The cathode active material and the cathode electrode may be the cathode active material 126 and the cathode electrode 120 of the electrochemical cell 100 of FIGS. 1 and 2 or the electrochemical cell 200 of FIG. 5. In one or more embodiments, the disposing the cathode active material may include pressing the cathode active material to at least one side of the porous conductive strip. In one or more embodiments, disposing the cathode active material includes coating the porous conductive strip with cathode active material. For example, disposing the cathode active material may include coating the porous conductive strip with a slurry that includes the active cathode active material and one or more liquids and drying the slurry coating the porous conductive strip. The slurry may also include one or more binders. Drying of the slurry may remove the one or more liquids or binders and leave the active cathode material on the porous conductive strip. Drying the slurry may include heating the slurry to a temperature that causes the one or more liquids or binders to evaporate without impairing the integrity of the cathode active material or the porous conductive strip.

The method 300 may include winding the cathode electrode about a longitudinal axis to form a plurality of cathode windings 306. To wind the core to form a partially wound cell core, the method 300 may include engaging one or more notches (e.g., the one or more notches 144 of FIGS. 3 and 4) of the winding core with a winding tool. Winding the core may include rotating the winding core around the longitudinal axis using the winding tool. The winding tool may include, for example, a chuck, a spindle, a motor, or any other device or apparatus to hold and rotate the winding core.

Winding the cathode electrode may include coupling the cathode electrode to a winding core. Coupling the cathode electrode to the winding core may include mechanically coupling the cathode electrode to the winding core. In some embodiments, the cathode electrode may also be electrically coupled to the winding core. The cathode electrode may be coupled to the winding core using any suitable technique or techniques. For example, coupling the cathode electrode to the winding core may include one or more of, for example, welding the cathode electrode to the winding core, adhering the cathode electrode to the winding core, soldering the cathode electrode to the winding core, fixing an edge of the cathode electrode between two or more pins of the winding core, disposing a portion of the cathode electrode in a groove of the winding core etc. In one or more embodiments, coupling the cathode electrode to the winding core includes welding the cathode electrode to the winding core. In one or more embodiments, coupling the cathode electrode to the winding core comprises laser welding the cathode electrode and a current collector (e.g., cathode current collector 110 of FIG. 1, 2, or 5) to the winding core.

The method 300 may also include disposing a separator (e.g., separator 128 of FIGS. 2 and 3) around the cathode electrode prior to winding the cathode electrode around the winding core 308. In one or more embodiments, disposing the separator around the cathode electrode may include inserting the cathode electrode into a separator tube or cylinder. In one or more embodiments, disposing the separator around the cathode electrode may include wrapping a separator around the cathode electrode such that the separator defines an annular ring, tube, or hollow cylinder around the cathode electrode.

The method 300 may include disposing an anode electrode around the separator to form a cell core 310. The anode electrode may be the anode electrode 122 of FIGS. 2 and 3 or the anode electrode 222 of FIG. 5. In one or more embodiments, disposing the anode electrode around the cathode electrode may include inserting the cathode electrode into an anode electrode tube or cylinder. In one or more embodiments, disposing the anode electrode around the cathode electrode may include wrapping an anode electrode around the cathode electrode. The anode electrode may be disposed or wrapped such that the anode electrode defines an annular ring, tube, or hollow cylinder around the cathode electrode. In one or more embodiments, disposing the anode electrode may include winding the anode electrode around a separator. Winding the anode electrode around the separator may form a plurality of anode windings surrounding the separator and the cathode electrode. Disposing the anode electrode may include electrically coupling the anode electrode to an anode current collector (e.g., anode current collector 212 of FIG. 5).

The method 300 may further include disposing the cell core into a cell housing (e.g., cell body 104 of FIGS. 1 and 2) 312. Disposing the cell core into the cell housing may include disposing the cell core into a cell body, coupling a distal header (e.g., distal header 106 of FIGS. 1 and 2 or distal header 206 of FIG. 5) to the distal end of the cell body, and coupling a proximal header (e.g., proximal header 108 of FIGS. 1 and 2 or proximal header 208 of FIG. 5) to the proximal end of the cell body. Coupling the distal header to the cell body may include welding the distal header to the cell body. Coupling the proximal header to the cell body may include welding the distal header to the cell body. The cell body, distal header, and proximal header may form the cell housing (e.g., cell housing 102 of FIGS. 1, 2, and 5). The method 300 may further include disposing an electrolyte into the cell housing.

The method 300 may further include disposing the cell core in an insulator cup (e.g., insulator cup 232 of FIG. 5). Disposing the cell core in the insulator cup may include inserting the cell core in the insulator cup. Disposing the cell core in the insulator cup may further include applying heat to the insulator cup after the cell core is received in the insulator cup to cause the insulator cup to shrink fit to the cell core.

The method 300 may further include disposing one or more coaxial insulators (e.g., coaxial insulators 134 of FIG. 2) ends of the cell core such that the one or more coaxial insulators insulate edges of the plurality of windings. At least one coaxial insulator may be disposed prior to disposing the cell core in an insulator cup.

The invention is defined in the claims. However, below there is provided a non-exhaustive list of non-limiting examples. Any one or more of the features of these examples may be combined with any one or more features of another example, embodiment, or aspect described herein.

Example Ex1: An electrochemical cell comprising a cell housing comprising a cell body extending along a longitudinal axis from a distal end to a proximal end; and a cell core disposed in the cell housing, the cell core comprising a cathode electrode defining a plurality of cathode windings around the longitudinal axis, each cathode winding comprising a porous conductive strip; and a cathode active material disposed on the porous conductive strip; an anode electrode disposed around the cathode electrode; and a separator disposed between the cathode electrode and the anode electrode.

Example Ex2: The electrochemical cell as in example Ex1, wherein cathode active material defines a coating disposed on the porous conductive strip.

Example Ex3: The electrochemical cell as in example Ex1, wherein the cathode active material is disposed on a single side of the porous conductive strip.

Example Ex4: The electrochemical cell as in example Ex1, wherein the porous conductive strip comprises a metal foil.

Example Ex5: The electrochemical cell as in example Ex1, wherein the porous conductive strip comprises a conductive polymer.

Example Ex6: The electrochemical cell as in example Ex1, further comprising a cathode current collector extending through the cell housing such that an inner portion of the cathode current collector is disposed inside the cell housing and is electrically coupled to the porous conductive strip and an outer portion of the cathode current collector is disposed outside of the cell housing.

Example Ex7: The electrochemical cell as in example Ex1, wherein the anode electrode defines a hollow cylinder surrounding the cathode electrode.

Example Ex8: The electrochemical cell as in example Ex1, wherein the anode electrode comprises a plurality of anode windings around the longitudinal axis.

Example Ex9: The electrochemical cell as in example Ex1, wherein the anode electrode is electrically coupled to the cell housing.

Example Ex10: The electrochemical cell as in example Ex1, wherein the separator defines a hollow cylinder arranged between the cathode electrode and the anode electrode.

Example Ex11: The electrochemical cell as in example Ex1, further comprising an insulator disposed between the anode electrode and the cell housing.

Example Ex12: The electrochemical cell as in example Ex1, wherein the cell core further comprises a winding core extending along the longitudinal axis.

Example Ex13: A method for forming an electrochemical cell comprising providing a porous conductive strip; disposing a cathode active material on the porous conductive strip to form a cathode electrode; winding the cathode electrode about a longitudinal axis to form a plurality of cathode windings; disposing a separator around the cathode electrode; disposing an anode electrode around the separator to form a cell core; and disposing the cell core into a cell housing.

Example Ex14: The method as in example Ex13, wherein providing the porous conductive strip comprises providing a metal foil; and disposing a plurality of holes in the metal foil to form the porous conductive strip.

Example Ex15: The method as in example Ex13, wherein providing the porous conductive strip comprises providing a strip of conductive polymer; and disposing a plurality of holes in the strip of conductive polymer to form the porous conductive strip.

Example Ex16: The method as in example Ex13, wherein disposing the cathode active material comprises pressing the cathode active material to at least one side of the porous conductive strip.

Example Ex17: The method as in example Ex14, wherein disposing the cathode active material comprises coating the porous conductive strip with a slurry comprising the active cathode active material and one or more liquids; and drying the slurry coating the porous conductive strip.

Example Ex18: The method as in example Ex13, wherein the anode electrode defines a hollow cylinder.

Example Ex19: The method as in example Ex13, wherein the separator defines a hollow cylinder.

Example Ex20: The method as in example Ex13, wherein disposing the anode electrode comprises winding the anode electrode around the separator.

Example Ex21: The method as in example Ex13, further comprising electrically coupling the anode electrode to a current collector extending through and insulated from the cell housing.

Example Ex22: The method as in example Ex13, further comprising electrically coupling the anode to the cell housing.

Example Ex23: The method as in example Ex13, further comprising disposing an electrolyte into the cell housing.

Example Ex24: The method as in example Ex13, wherein the disposing the cell core into the cell housing comprises disposing the cell core in a cell body; coupling a distal header to a distal end of the cell body; and coupling a proximal header to a proximal end of the cell body.

All scientific and technical terms used herein have meanings commonly used in the art unless otherwise specified. The definitions provided herein are to facilitate understanding of certain terms used frequently herein and are not meant to limit the scope of the present disclosure.

As used herein, singular forms “a,” “an” and “the” include plural referents unless the context clearly dictates otherwise. As used in this specification and the appended claims, the term “or” is generally employed in its sense including “and/or” unless the content clearly dictates otherwise. The term “and/or” means one or all of the listed elements or a combination of any two or more of the listed elements.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred. Any recited single or multiple feature or aspect in any one claim can be combined or permuted with any other recited feature or aspect in any other claim or claims.

It will be apparent to those skilled in the art that various modifications and variations can be made to the present inventive technology without departing from the spirit and scope of the disclosure. Since modifications, combinations, sub-combinations and variations of the disclosed embodiments incorporating the spirit and substance of the inventive technology may occur to persons skilled in the art, the inventive technology should be construed to include everything within the scope of the appended claims and their equivalents.

1. An electrochemical cell comprising:
a cell housing comprising a cell body extending along a longitudinal axis from a distal end to a proximal end; and
a cell core disposed in the cell housing, the cell core comprising:
a cathode electrode defining a plurality of cathode windings around the longitudinal axis, each cathode winding comprising:
a porous conductive strip; and
a cathode active material disposed on the porous conductive strip;
an anode electrode disposed around the cathode electrode; and
a separator disposed between the cathode electrode and the anode electrode.

2. The electrochemical cell as in claim 1, wherein cathode active material defines a coating disposed on the porous conductive strip.

3. The electrochemical cell as in claim 1, wherein the cathode active material is disposed on a single side of the porous conductive strip.

4. The electrochemical cell as in claim 1, wherein the porous conductive strip comprises a metal foil.

5. The electrochemical cell as in claim 1, wherein the porous conductive strip comprises a conductive polymer.

6. The electrochemical cell as in claim 1, further comprising a cathode current collector extending through the cell housing such that an inner portion of the cathode current collector is disposed inside the cell housing and is electrically coupled to the porous conductive strip and an outer portion of the cathode current collector is disposed outside of the cell housing.

7. The electrochemical cell as in claim 1, wherein the anode electrode defines a hollow cylinder surrounding the cathode electrode.

8. The electrochemical cell as in claim 1, wherein the anode electrode comprises a plurality of anode windings around the longitudinal axis.

9. The electrochemical cell as in claim 1, wherein the anode electrode is electrically coupled to the cell housing.

10. The electrochemical cell as in claim 1, wherein the separator defines a hollow cylinder arranged between the cathode electrode and the anode electrode.

11. The electrochemical cell as in claim 1, further comprising an insulator disposed between the anode electrode and the cell housing.

12. The electrochemical cell as in claim 1, wherein the cell core further comprises a winding core extending along the longitudinal axis.

13. A method for forming an electrochemical cell according to claim 1 comprising:
providing a porous conductive strip;
disposing a cathode active material on the porous conductive strip to form a cathode electrode;
winding the cathode electrode about a longitudinal axis to form a plurality of cathode windings;
disposing a separator around the cathode electrode;
disposing an anode electrode around the separator to form a cell core; and
disposing the cell core into a cell housing.

14. The method as in claim 13, wherein providing the porous conductive strip comprises:
providing a metal foil; and
disposing a plurality of holes in the metal foil to form the porous conductive strip.

15. The method as in claim 13, wherein providing the porous conductive strip comprises:
providing a strip of conductive polymer; and
disposing a plurality of holes in the strip of conductive polymer to form the porous conductive strip.

16. The method as in claim 13, wherein disposing the cathode active material comprises pressing the cathode active material to at least one side of the porous conductive strip.

17. The method as in claim 14, wherein disposing the cathode active material comprises:
coating the porous conductive strip with a slurry comprising the active cathode active material and one or more liquids; and
drying the slurry coating the porous conductive strip.

18. The method as in claim 13, wherein the anode electrode defines a hollow cylinder.

19. The method as in claim 13, wherein the separator defines a hollow cylinder.

20. The method as in claim 13, wherein disposing the anode electrode comprises winding the anode electrode around the separator.
